(19) United States
(12) Patent Application Publication
(10) Pub. No.: US 2021/0031776 A1
(43) Pub. Date: Feb. 4, 2021

(54) DISPLAY CONTROL UNIT AND NON-TRANSITORY TANGIBLE COMPUTER READABLE STORAGE MEDIUM

(71) Applicant: DENSO CORPORATION, Kariya-city (JP)

(72) Inventors: Shunsuke SHIBATA, Nisshin-city (JP); Takeshi HATO, Kariya-city (JP); Daisuke TAKEMORI, Kariya-city (JP); Hiroto BANNO, Kariya-city (JP)

(21) Appl. No.: 17/075,950

(22) Filed: Oct. 21, 2020

Related U.S. Application Data
(63) Continuation of application No. PCT/JP2019/013436, filed on Mar. 27, 2019.

(30) Foreign Application Priority Data
Apr. 24, 2018 (JP) 2018-083130

(51) Int. Cl. B60W 40/06; B60K 35/00; B60W 50/08

(52) U.S. Cl. CPC B60W 40/06; B60K 35/00; B60W 2552/35; B60K 2370/152; B60K 2370/151; B60W 50/08

(57) ABSTRACT

A display control unit controls a virtual image display device that superimposes a virtual image on a foreground of an occupant of the vehicle. The display control unit acquires posture information indicating a change in posture of the vehicle based on a signal of a posture sensor attached to the vehicle. The display control unit acquires driving force information indicating a state of a driving force acting on the vehicle. The display control unit determines that the vehicle is traveling on a rough road when the change in posture indicated by the posture information exceeds a threshold value in a state where the driving force indicated by the driving force information is stable.

### CROSS REFERENCE TO RELATED APPLICATIONS

The present application is a continuation application of International Patent Application No. PCT/JP2019/013436 filed on Mar. 27, 2019, which designated the U.S. and claims the benefit of priority from Japanese Patent Application No. 2018-083130 filed on Apr. 24, 2018. The entire disclosures of all of the above applications are incorporated herein by reference.

### TECHNICAL FIELD

The present disclosure relates to a display control unit and a non-transitory tangible computer readable storage medium for determining a rough road.

### BACKGROUND

For example, devices for automatically adjusting a direction of an optical axis of a headlight provided in a vehicle have been proposed. One of the devices includes road surface state determining means for determining a road surface condition. The road surface condition determination means calculates a variance value of a pitch angle change rate based on a signal of a height sensor, and determines that a road is rough when the variance value is equal to or greater than a threshold value.

### SUMMARY

The present disclosure provides a display control unit that controls a virtual image display device configured to superimpose a virtual image on a foreground of an occupant of a vehicle. The display control unit acquires posture information indicating a change in posture of the vehicle based on a signal of a posture sensor attached to the vehicle. The display control unit acquires driving force information indicating a state of a driving force acting on the vehicle. The display control unit determines that the vehicle is traveling on a rough road when the change in posture indicated by the posture information exceeds a threshold value in a state where the driving force indicated by the driving force information is stable.

### BRIEF DESCRIPTION OF DRAWINGS

The features and advantages of the present disclosure will become more apparent from the following detailed description made with reference to the accompanying drawings. In the drawings:

FIG. 1 is a block diagram showing an overall image of an in-vehicle configuration related to a virtual image display system;

FIG. 2 is a diagram showing an example of AR display using a virtual image;

FIG. 3 is a flowchart showing a display correction process executed by a display control device according to a first embodiment;

FIG. 4 is a diagram showing a display example when a display position of a virtual image is deviated due to a posture change;

FIG. 5 is a diagram showing a display example when the deviation of the display position of the virtual image is corrected by a correction control; and

FIG. 6 is a flowchart showing a display correction process according to a second embodiment.

### DETAILED DESCRIPTION

For example, in a determination logic for performing rough road determination by calculating a variance value, measured data for several seconds by a height sensor is required from an occurrence of a posture change to the rough road determination. With the measured data, a posture change due to the acceleration and deceleration of the vehicle can be distinguished from a posture change due to the rough road travel. Therefore, it has been difficult to shorten a period of time to the rough road determination while securing the accuracy of the rough road determination.

The present disclosure provides a display control unit and a non-transitory tangible computer readable storage medium each of which can shorten a period of time from an occurrence of a posture change to a rough road determination.

An exemplary embodiment of the present disclosure provides a display control unit that control a virtual image display device configured to superimpose a virtual image on a foreground of an occupant of a vehicle. The display control unit includes a posture information acquisition unit, a drive information acquisition unit, a rough road determination unit, and a correction unit. The posture information acquisition unit acquires posture information indicating a change in posture of the vehicle based on a signal of a posture sensor attached to the vehicle. The drive information acquisition unit acquires driving force information indicating a state of a driving force acting on the vehicle. The rough road determination unit determines that the vehicle is traveling on a rough road when the change in posture indicated by the posture information exceeds a threshold value in a state where the driving force indicated by the driving force information is stable. The correction unit (i) corrects a deviation of a display position of the virtual image with respect to the foreground due to the change in posture of the vehicle based on the posture information, and (ii) inhibits the display position of the virtual image from being corrected and continues to superimpose the virtual image on the foreground when the rough road determination unit determines that the vehicle is traveling on the rough road.

Another exemplary embodiment of the present disclosure provides a non-transitory tangible computer readable storage medium comprising instructions executed by at least one processor of a display control unit. The at least one processor controls a virtual image display device configured to superimpose a virtual image on a foreground of an occupant of a vehicle. The at least one processor is used for the vehicle to which a posture sensor is attached. The instructions comprising: acquiring posture information indicating a change in posture of the vehicle based on a signal of the posture sensor; acquiring driving force information indicating a state of a driving force acting on the vehicle; determining that the vehicle is traveling on a rough road when the change in posture indicated by the posture information exceeds a threshold value in a state where the driving force indicated by the driving force information is stable; correcting a deviation of a display position of the virtual image with respect to the foreground due to the change in posture of the vehicle based on the posture information; and inhibiting the display position of the virtual image from being corrected and continuing to superimpose the virtual image on the foreground in the determining that the vehicle is traveling on the rough road.

In the exemplary embodiment of the present disclosure, the rough road determination unit can detect a stable state of a driving force by use of driving force information. Therefore, the rough road determination unit can quickly distinguish a posture change caused by the rough road travel from the posture change caused by the acceleration and deceleration with respect to the posture change indicated by the posture information by the posture sensor. Therefore, the period of time from the occurrence of the posture change to the rough road determination can be shortened.

Embodiments of the present disclosure will be described with reference to the accompanying drawings. The same reference numerals may be used for the mutually corresponding elements in the embodiments to omit a duplicate description. A subsequent embodiment may describe only part of the configuration. In such a case, the other part of the configuration applies to the corresponding part of the configuration described in the preceding embodiment. Combinations of the configurations are not limited to those explicitly described in the embodiments. The configurations of the embodiments may be partially combined, even if not explicitly described, except an invalid combination. The description below will disclose an implicit combination of the embodiments and the configurations described in the modifications.

### First Embodiment

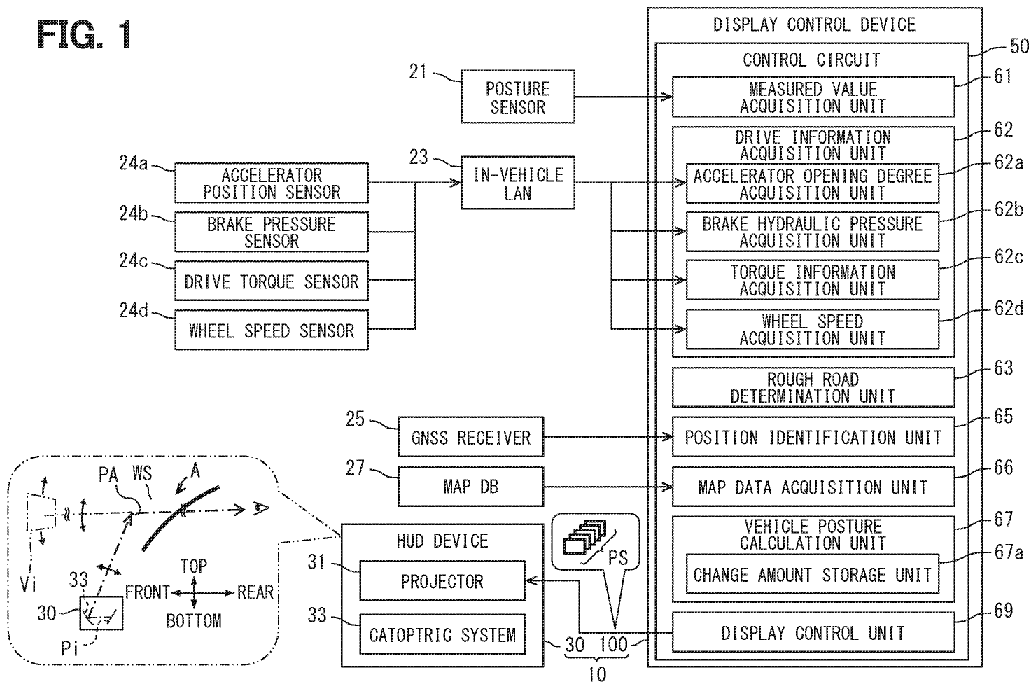

The functions of a rough road determination device and a display control unit according to a first embodiment of the present disclosure are realized by a display control device 100 shown in FIG. 1. The display control device 100 is one of multiple electronic control units for a vehicle A. The display control device 100 is electrically connected to a posture sensor 21, an in-vehicle LAN 23, a GNSS receiver 25, a map database (hereinafter, map DB) 27, an HUD device 30, and the like.

The posture sensor 21 is a sensor for detecting a change in posture of the vehicle A, and is a height sensor for detecting a vehicle height of the vehicle A as an example. The posture sensor 21 detects a vertical displacement generated in the vehicle A. The posture sensor 21 is, for example, installed outside a vehicle compartment and on any one of right and left rear suspension. The posture sensor 21 measures the amount of sinking of a specific wheel with respect to a body. The specific wheel is displaced in the vertical direction by the operation of suspension arms suspended on the body. The posture sensor 21 measures a relative distance between the body and the suspension arms, and sequentially outputs a signal (for example, a potential) of the measured data to the display control device 100.

The in-vehicle LAN (Local Area Network) 23 is an in-vehicle communication network installed in the vehicle A. Various electronic control units, sensors, and the like mounted on the vehicle A are connected to a communication bus of the in-vehicle LAN 23. Accelerator opening degree information (accelerator operation information) detected by an accelerator position sensor 24a and brake hydraulic pressure information (braking operation information) detected by a brake pressure sensor 24b are output to the in-vehicle LAN 23. Further, drive torque information detected by a drive torque sensor 24c, wheel speed information detected by a wheel speed sensor 24d, and the like are output to the in-vehicle LAN 23.

The GNSS (Global Navigation Satellite System) receiver 25 is capable of receiving positioning signals transmitted from multiple artificial satellites. The GNSS receiver 25 identifies the current position of the vehicle A based on the received positioning signals. The GNSS receiver 25 sequentially outputs the specified position information on the vehicle A to the display control device 100. The GNSS receiver 25 may include an inertial sensor for correcting position information based on the positioning signals.

The map DB 27 mainly includes a large-capacity storage medium for storing a large number of pieces of three-dimensional map data. The three-dimensional map data includes structural information indicating latitude, longitude, and altitude of each road, and non-transitory traffic regulation information such as speed limit and one-way traffic. The map DB 27 can update the three-dimensional map data to the latest information through, for example, a network. The Map DB 27 provide the display control device 100 with three-dimensional map data around the current position and a traveling direction of the vehicle A in response to a request from the display control device 100.

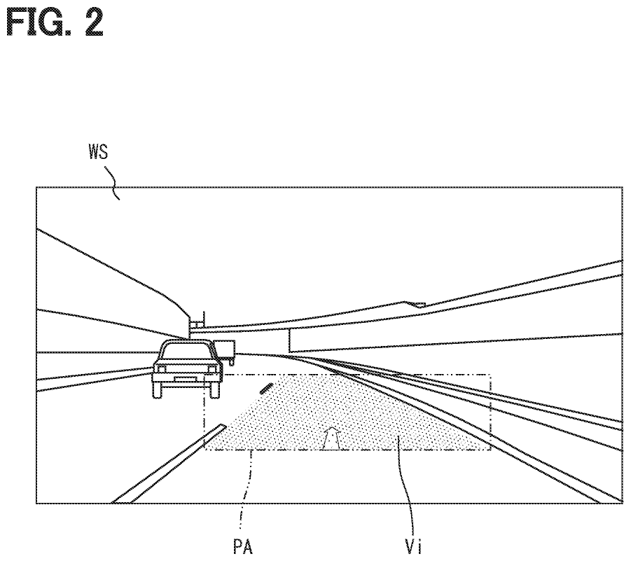

The HUD (Head-Up Display) device 30 is used in the vehicle A. The HUD device 30 configures the virtual image display system 10 together with the display control device 100, and displays the virtual image Vi on the front of the occupant of the vehicle A (for example, the driver) in a superimposed manner. The virtual image Vi is formed, for example, in a space in a range of about 10 to 20 m in front of the vehicle A from an eye point. For example, the virtual image Vi is formed about 15 m in front of the eye point. The HUD device 30 presents various types of information related to the vehicle A to the driver by displaying an augmented reality (hereinafter, Augmented Reality: AR) using the virtual image Vi superimposed on a real view (hereinafter, foreground) in front of the vehicle. As shown in FIG. 2, the HUD device 30 superimposes and displays the virtual image Vi on the road surface or the like on the appearance of the driver, and presents route guidance information for navigation to the driver.

As a configuration for realizing the AR display of the virtual image Vi as described above, the HUD device 30 shown in FIG. 1 includes a projector 31 and a catoptric system 33. The projector 31 emits a light of a display image Pi formed as the virtual image Vi toward the catoptric system 33 based on image data PS input from the display control device 100. As the projector 31, a laser projector, a liquid crystal projector, or the like can be employed.

The catoptric system 33 includes a reflection type screen and a reflecting mirror. The screen and the reflecting mirror are formed by depositing a metal such as aluminum on a surface of a colorless transparent base material made of synthetic resin, glass, or the like. The display image Pi is drawn on the screen by a light emitted from the projector 31. The reflecting mirror projects the display image Pi drawn on the screen onto a projection region PA (see FIG. 2) defined by a windshield WS. The light projected onto the windshield WS is reflected by the projection region PA toward the driver and reaches an eye box defined in advance so as to be located around a head of the driver. The driver who has positioned the eye point in the eye box can visually recognize the light of the display image Pi as the virtual image Vi superimposed on the foreground.

The display control device 100 is an arithmetic device that integrally controls the display of a large number of in-vehicle display devices mounted on the vehicle A. The display control device 100 controls a display position, a display mode, and the like of the virtual image Vi displayed by the HUD device 30. The display control device 100 has a rough road determination function as one of functions related to the display control of the virtual image Vi.

The control circuit 50 of the display control device 100 includes a processing unit, a RAM, a memory device, an interface, and the like. The processing unit includes at least one of a CPU (Central Processing Unit), a GPU (Graphics Processing Unit), and an FPGA (Field-Programmable Gate Array). Various programs to be executed by the processing unit are stored in the memory device. The multiple programs include a drawing program for drawing the image data PS, a posture estimation program for estimating a posture change of the vehicle A, and the like. The display control device 100 executes the drawing program and the posture estimation program by the processing unit, and configures functional units such as a measured value acquisition unit 61, a drive information acquisition unit 62, a rough road determination unit 63, a position identification unit 65, a map data acquisition unit 66, a vehicle posture calculation unit 67, and a display control unit 69.

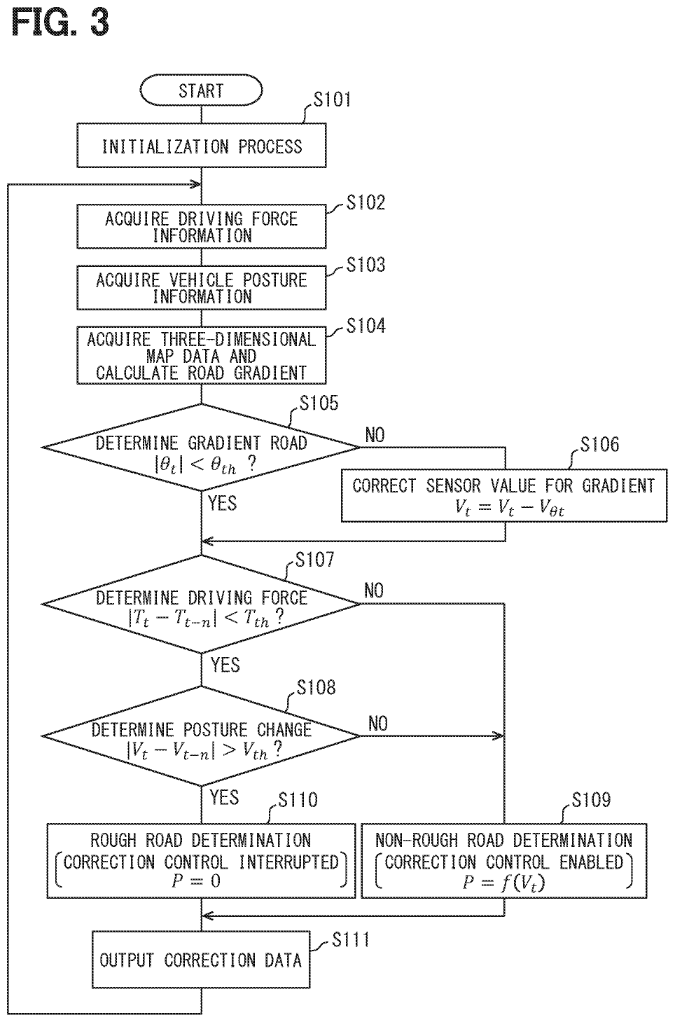

The measured value acquisition unit 61 acquires posture information indicating a change in the posture of the vehicle A based on a signal from the posture sensor 21. The measured value acquisition unit 61 installs a function of a low-pass filter for removing noise included in the signal of the posture sensor 21. The measured value acquisition unit 61 acquires an output value Vt (see FIG. 3) obtained by taking a moving average of the input signals of the posture sensor 21 as the posture information. The low-pass filter may be implemented as software or may be implemented as hardware. Parameters for rough road determination, which will be described later, can be appropriately adjusted in accordance with the setting of the low-pass filter.

The drive information acquisition unit 62 acquires at least the driving force information indicating a state of the driving force acting on the vehicle A. The driving force information is acceleration/deceleration information indicating acceleration and deceleration in the longitudinal direction acting on the vehicle A. The drive information acquisition unit 62 includes an accelerator opening degree acquisition unit 62a, a brake hydraulic pressure acquisition unit 62b, and a torque information acquisition unit 62c. The accelerator opening degree acquisition unit 62a acquires the accelerator opening degree information as the driving force information from the in-vehicle LAN 23. The brake hydraulic pressure acquisition unit 62b acquires the brake hydraulic pressure information as the driving force information from the in-vehicle LAN 23. The torque information acquisition unit 62c acquires the drive torque information as the driving force information from the in-vehicle LAN 23. In addition, the drive information acquisition unit 62 includes a wheel speed acquisition unit 62d. The wheel speed acquisition unit 62d calculates the present traveling speed (vehicle speed) of the vehicle A based on the wheel speed information acquired from the in-vehicle LAN 23.

The rough road determination unit 63 determines whether or not the road surface on which the vehicle is traveling is a rough road by combining the driving force determination as to whether or not the driving force indicated by the driving force information is in a stable state and the posture change determination as to whether or not the vehicle posture indicated by the posture information is in a stable state together. For example, unpaved roads, roads with significant steps at seams, roads with significant road surface roughness, and the like correspond to rough roads. When the driving force is in a stable state and the vehicle posture is in a change state, the rough road determination unit 63 determines that the vehicle is traveling on a rough road having large road surface irregularities. When it is determined that the vehicle A is traveling on a rough road, the rough road determination unit 63 continues the determination of the rough road for a predetermined period of time (for example, several seconds).

More specifically, in order to determine the driving force state, the rough road determination unit 63 observes the amount of change per unit time of the accelerator opening degree, the brake hydraulic pressure, the drive torque, and the like acquired as the driving force information. When the change indicated by the driving force information is maintained within a predetermined value for a predetermined period of time or longer, the rough road determination unit 63 determines that the driving force is in a stable state. As an example, the rough road determination unit 63 determines that the driving force is in a stable state when all the amounts of change of the respective driving force information during a predetermined period of time fall below a threshold value Tth. The threshold value Tth may be referred to as a driving force threshold value Tth. On the other hand, when the amount of change in at least one driving force information is equal to or larger than the threshold value Tth, the rough road determination unit 63 determines that the driving force information is changed (see S107 in FIG. 3).

In addition, the rough road determination unit 63 observes the amount of change per unit time of the output value Vt (see FIG. 3) of the posture sensor 21 acquired as the posture information. The rough road determination unit 63 determines that the vehicle posture is in a changed state when the amount of change in the output value Vt during a predetermined period of time becomes equal to or greater than a predetermined threshold value Vth. The threshold value Vth may be referred to as posture threshold value Vth. On the other hand, when the amount of change in the output value Vt for a predetermined period of time is less than the threshold value Vth, the rough road determination unit 63 determines that the vehicle posture is stable (see S108 in FIG. 3).

Furthermore, the rough road determination unit 63 can change the content of the rough road determination in accordance with the vehicle speed of the vehicle A. The rough road determination unit 63 changes a predetermined period of time (time width) used for the driving force determination and the posture change determination in accordance with the vehicle speed. For example, when the vehicle speed is lower than a specific threshold value, the rough road determination unit 63 adjusts the time width to be longer. Such adjustment improves robustness against disturbances in the driving force determination and the posture change determination. In addition, the rough road determination unit 63 adjusts determination criteria (each threshold value) related to the rough road determination in accordance with the vehicle speed. Specifically, when the vehicle speed is lower than a specific low speed determination threshold value, the rough road determination unit 63 increases the threshold value Vth used for the posture change determination, and makes it difficult to determine that the rough is rough.

The position identification unit 65 acquires position information indicating the current position of the vehicle A from the GNSS receiver 25. The map data acquisition unit 66 refers to the position information acquired by the position identification unit 65, and requests the map DB 27 to provide the three-dimensional map data around the current position of the vehicle A. Through the above request processing, the map data acquisition unit 66 acquires three-dimensional map data including latitude, longitude, and altitude information for roads on which the vehicle is traveling and is scheduled to travel.

The vehicle posture calculation unit 67 calculates a road gradient et (see FIG. 3) for a road on which the vehicle is traveling, based on the three-dimensional map data acquired by the map data acquisition unit 66. As an example, the road gradient et has a positive value on an uphill road and a negative value on a downhill road. When an absolute value of the road gradient et estimated from the three-dimensional map data is less than the threshold value θth, the vehicle posture calculation unit 67 determines that the road is a non-gradient road. The threshold value θth may be referred to as a gradient threshold value θth. On the other hand, when the absolute value of the road gradient et is equal to or greater than the threshold value θth, the vehicle posture calculation unit 67 determines that the road is a gradient road (see S105 in FIG. 3).

The vehicle posture calculation unit 67 corrects the amount of change in the output value Vt of the posture sensor 21 caused by the own weight of the vehicle A on the gradient road when the vehicle posture calculation unit 67 determines that the road is the gradient road. The vehicle posture calculation unit 67 includes a change amount storage unit 67a that stores the correlation data CD. In the correlation data CD, a correlation between the magnitude of the road gradient et and the correction value of the posture sensor 21 is defined in advance. The vehicle posture calculation unit 67 calculates the amount of change caused by the gradient included in the output value Vt of the posture sensor 21 as the gradient correction value Vet by a calculation processing of applying the current road gradient et to the correlation data CD. The vehicle posture calculation unit 67 subtracts the calculated gradient correction value Vet from the output value Vt acquired by the measured value acquisition unit 61, thereby acquiring a corrected output value Vt obtained by subtracting the amount of change caused by the gradient (see S106 in FIG. 3).

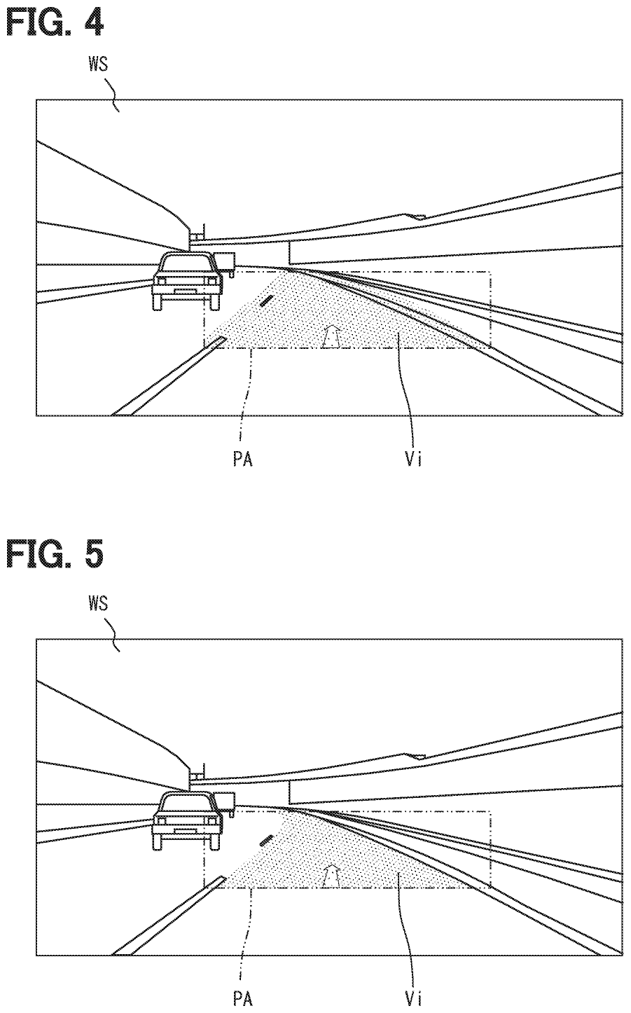

The display control unit 69 generates image data PS used for the virtual image display, and outputs the image data PS to the projector 31 of the HUD device 30. In the AR display in which the virtual image Vi is superimposed on the foreground as in the HUD device 30 described above, when the posture of the vehicle A changes, the virtual image Vi is deviated from the supposed superimposition target on the appearance of the driver (see FIG. 4). The display control unit 69 has a function of generating and outputting correction data as a correction function of reducing the deviation of the display position of the virtual image Vi.

More specifically, a correction function for correcting the deviation of the display position is set in advance in the display control unit 69. In the correction function, the output value Vt of the posture sensor 21 indicating the magnitude of the posture change is used as an input variable. The display control unit 69 continuously calculates the correction value P by a calculation processing of applying the output value Vt of the posture sensor 21 to the correction function (see S109 in FIG. 3). The correction value P is a value related to a pitching angle of the vehicle A. Since the correction value P is calculated by use of the correction function, the correction value P follows the magnitude of the posture change and becomes a value that changes. The display control unit 69 sequentially outputs the continuously calculated correction values P as the correction data described above to the projector 31 together with the image data PS.

Based on the correction data described above, the HUD device 30 corrects the deviation of the display position of the virtual image Vi caused by the change in the posture of the vehicle A. More specifically, the display image Pi projected by the projector 31 is a part of an image of each frame configuring the image data PS. In other words, an image size of each frame image in the image data PS is slightly larger than an image size of the display image Pi projected by the projector 31. The projector 31 cuts out a range that correctly cuts out a range which is superimposed on the superimposition target on the appearance of the driver from each frame image. In other words, when the posture of the vehicle A changes, the projector 31 changes the range to be cut out from each frame image by referring to the correction data.

For example, when a pitch change that causes the rear side to sink with acceleration occurs in the vehicle A, the foreground range seen by the driver over the projection region PA moves upward as compared with the foreground range before the posture changes (see FIGS. 2 and 4). In that case, the projector 31 moves the range to be cut out from each frame image upward by referring to the correction data. With the processing described above, even if the range of the foreground that is superimposed on the projection region PA on the appearance of the driver changes, the virtual image Vi having a correct shape is superimposed on the superimposing target in the foreground that is visually recognized through the projection area PA (see FIG. 5).

In this example, in the current HUD device 30, it is assumed that the delay of the display position correction occurs on the high-frequency vibration during traveling on a rough road due to a drawing delay, a communication delay, or the like. The correction delay described above annoys the driver. Therefore, the display control unit 69 inhibits the correction control of the display position of the virtual image Vi in the scene in which the vehicle A travels on the rough road. More specifically, the display control unit 69 substantially interrupts the correction control when the road on which the vehicle is traveling is determined to be a rough road by the rough road determination unit 63. When the correction control of the display position is temporarily interrupted in accordance with the rough road determination, the display control unit 69 continues the interruption of the correction control for a predetermined period of time (for example, several seconds).

Further, the display control unit 69 inhibits the correction control of the display position even when it is determined that the road surface is a rough road while traveling on an uphill road and a downhill road in which an absolute value of the road gradient θt exceeds the threshold value θth. In that case, the display control unit 69 continues the correction to the posture change caused by the gradient while substantially interrupting the correction to the vibration caused by the rough road. As described above, the display control unit 69 moves, for example, the virtual image Vi linearly from the current position toward the gradient correction position after determination that the road is a gradient road and a rough road.

The gradient correction position described above is a display position at which a deviation of the virtual image Vi due to a gradient factor is corrected. In the display control unit 69, a gradient correction function for calculating a correction gradient position is set in advance. In the gradient correction function, for example, the road gradient et is used as an input variable. The display control unit 69 generates correction data for defining the gradient correction position by performing a calculation processing for applying the road gradient et to the gradient correction function on the basis of the determination that the road is a gradient road and a rough road. When the projector 31 refers to the correction data described above, the virtual image Vi is displayed at the gradient correction position, and is superimposed on the superimposing target in the foreground without substantial deviation.

Details of the display correction process performed by the display control device 100 will be described based on FIG. 3 with reference to FIG. 1. The display correction process shown in FIG. 3 is started based on, for example, turning on of the power supply of the vehicle A, and is repeated until an ignition is turned off.

In S101, an initialization process of the control circuit 50 resets the respective values of the posture information, the driving force information, and the correction data, and the like and proceeds to S102. In S102, the latest driving force information is acquired from the in-vehicle LAN 23, and the process proceeds to S103. In S103, the latest posture information, that is, the output value Vt is acquired from the posture sensor 21, and the process proceeds to S104. In S104, three-dimensional map data around the current location is acquired based on the latest position information. Then, the road gradient et of the road on which the vehicle is traveling is calculated by use of the information of latitude, longitude, and altitude indicated by the three-dimensional map data, and the process proceeds to S105.

In S105, it is determined whether or not the road on which the vehicle is traveling is a gradient road by use of the value of the road gradient et calculated in S104. When it is determined in S105 that an absolute value of the latest road gradient et is less than the threshold value θth, it is estimated that the vehicle is traveling on a substantially horizontal road, and the process proceeds to S107.

On the other hand, when it is determined in S105 that the absolute value of the road gradient et is equal to or greater than the threshold value θth, it is estimated that the vehicle is traveling on the gradient road, and the process proceeds to S106. In S106, the gradient correction value Vet is calculated by applying the road gradient et to the correlation data CD. Then, the gradient correction value Vet is subtracted from the output value Vt to correct the output value Vt, and the process proceeds to S107.

In S107, a difference between a latest value Tt and a past value Tt−n prior to a predetermined period of time (t−n) is calculated as the amount of change in the respective driving force information in the predetermined time. Then, a state of the driving force of the vehicle A is determined by comparing each change amount (absolute value of the difference) in a predetermined period of time with each threshold value Tth. When it is determined in S107 that the amount of change in at least one of the driving force information per constant period of time is equal to or greater than the threshold value Tth and the driving force is in a changed state, the process proceeds to S109. On the other hand, when it is determined that the amount of change in all the driving force information per constant period of time is less than the threshold value Tth and the driving force is in a stable state, the process proceeds to S108.

In S108, a difference between the latest output value Vt and the output value Vt-n before the predetermined time is calculated as the amount of change in the posture information per constant period of time. Then, a state of the change in the posture of the vehicle A is determined by comparing the amount of change (absolute value of the difference) in a predetermined period of time with the threshold value Vth. When it is determined in S108 that the amount of change during the predetermined period is equal to or less than the threshold value Vth and the vehicle posture is in a stable state, the vehicle posture proceeds to S109.

In S109, it is determined that the road on which the vehicle is traveling is not a rough road (non-rough road determination), and the correction control of the display position is enabled or an enabled state is maintained. In this instance, a correction value P obtained by substituting the output value Vt of the posture sensor 21 into the correction function is calculated, and the process proceeds to S111.

On the other hand, when it is determined in S108 that the amount of change per the predetermined period of time exceeds the threshold value Vth and the posture of the vehicle is in the changed state, the process proceeds to S110. In S110, it is determined that the road on which the vehicle is traveling is a rough road (rough road determination), and the correction control of the display position is interrupted or an interrupted state is maintained. In this instance, the correction value P is set to a predetermined value (e.g., 0) and the process proceeds to S111. Incidentally, in S110, a correction value P obtained by applying the road gradient et to the gradient correction function may be calculated instead of the predetermined value.

In S111, the correction value P calculated in S109 or S110 is output as the correction data to the projector 31 together with the image data PS. As described above, in the HUD device 30, the display image Pi based on the image data PS reflecting the correction data is drawn on the screen by the projector 31.

The rough road determination unit 63 according to the first embodiment described so far can detect the stable state of the driving force by use of the driving force information. Therefore, the rough road determination unit 63 can quickly distinguish the posture change caused by the rough road travel from the posture change caused by the acceleration and deceleration with respect to the posture change indicated by the posture information. Therefore, the period of time from the occurrence of the posture change to the rough road determination can be shortened.

In addition, in the first embodiment, the accelerator opening degree information, the brake hydraulic pressure information, and the drive torque information are used as the driving force information for determining the stable state of the driving force. As described above, when multiple pieces of driving force information are acquired by the drive information acquisition unit 62, the rough road determination unit 63 can determine the stable state of the driving force with high accuracy. In addition, when the accelerator opening degree information and the drive torque information related to the acceleration and the brake hydraulic pressure information related to the deceleration are combined together, the rough road determination unit 63 can accurately distinguish both of the acceleration state and the deceleration state from each other as the change state of the driving force.

In the first embodiment, when it is determined by the rough road determination unit 63 that the road is not a rough road, the display position of the virtual image Vi is corrected by the display control unit 69 so that the positional deviation of the virtual image Vi caused by the posture change is reduced (traded-off). According to the correction control described above, even when the HUD device 30 for presenting information by the virtual image Vi superimposed on the foreground is employed in the vehicle A, the sense of discomfort due to display fluctuation caused by acceleration and deceleration, gradient, or the like is effectively reduced.

Further, in the first embodiment, when it is determined that the road is a rough road by the rough road determination unit 63, the display control unit 69 inhibits the correction control of the display position of the virtual image Vi. Therefore, a situation in which the virtual image display becomes bothersome due to the control for correcting the high-frequency vehicle vibration caused by the unevenness of the road surface is reduced.

In addition, in the first embodiment, when the vehicle A is traveling at a low speed, the adjustment for weakening the criterion of the rough road determination makes it difficult to cause the interruption of the correction control. During a low-speed driving, the frequency of vehicle vibration generated by road surface irregularities is also low. This makes it difficult to delay the correction control. For that reason, with the adjustment that makes it difficult to determine that the vehicle is traveling on a rough road at a low speed, the correction control can be effectively functioned in many traveling scenes while avoiding the occurrence of bothersome virtual image display.

In the first embodiment, even when the vehicle is traveling on the gradient road, when the road is not a rough road, the correction control of the display position is enabled. On the other hand, when it is determined that the road is a gradient road and a rough road, the correction control is disabled. As described above, in the case of the processing for performing the rough road determination even in the gradient road, the situation in which the bothersome virtual image display is performed can be reduced even on the gradient road.

Further, in the first embodiment, when it is determined that the road is a rough road while traveling on the gradient road, the display position of the virtual image Vi asymptotically approaches the gradient correction position from the current position. The transition of the display position described above substantially stops a discontinuous movement of the virtual image display position based on the rough road determination. According to the above configuration, a situation in which the sense of discomfort of the virtual image display becomes conspicuous by switching the correction control between an enabled state and a disabled state accompanied by the rough road determination hardly occurs.

In addition, the rough road determination unit 63 according to the first embodiment continues the rough road determination for a predetermined period of time when it is once determined that the road on which the vehicle is traveling is a rough road. When the correction control is temporarily interrupted based on the rough road determination, the display control unit 69 continues the interruption of the correction control for a predetermined period of time. As described above, when the result of the rough road determination or the interruption of the correction control is continued for a predetermined period of time, the display control unit 69 can maintain an interruption state of the correction control even when the rough road determination is erroneously released during traveling on the rough road. As a result, the uncomfortable feeling caused by the display fluctuation of the virtual image Vi is more effectively reduced.

In the first embodiment, the display control device 100 corresponds to a rough road determination device and a display control unit, and the HUD device 30 corresponds to a virtual image display device. Further, the control circuit 50 corresponds to a processing unit, the measured value acquisition unit 61 corresponds to a posture information acquisition unit, the position identification unit 65 corresponds to a position information acquisition unit, and the display control unit 69 corresponds to a correction unit.

### Second Embodiment

A second embodiment according to the present disclosure is a modification of the first embodiment. In the second embodiment, when an absolute value of a road gradient et estimated by a vehicle posture calculation unit 67 shown in FIG. 1 is equal to or larger than a threshold value θth, the rough road determination unit 63 stops determining whether or not the road is a rough road. As described above, the display control unit 69 maintains a state of enabling the correction control while traveling on an uphill road or a downhill road.

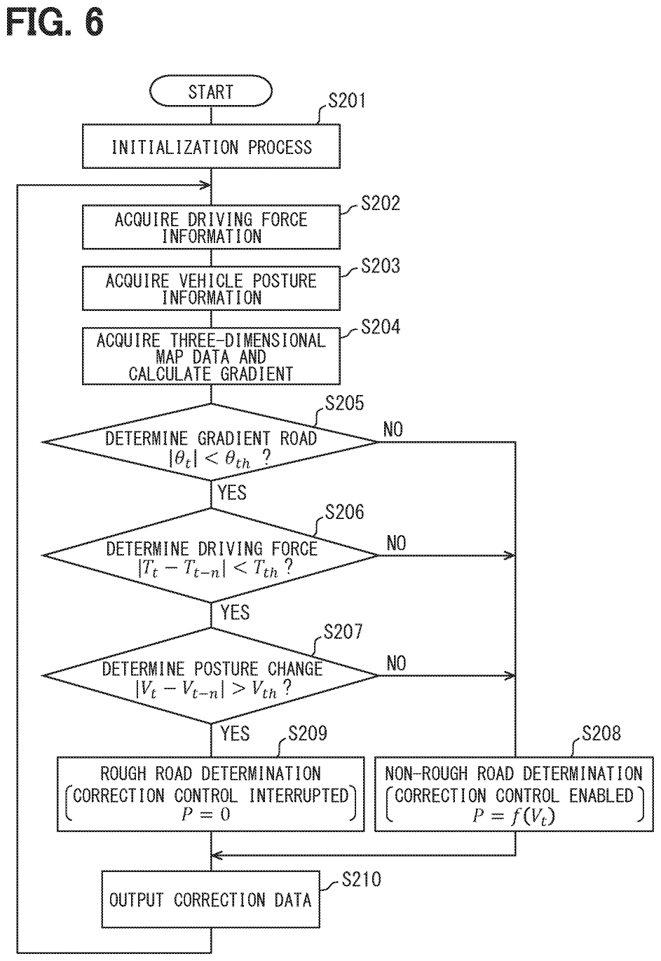

In order to realize the control described above, in S205 of the display correction process according to the second embodiment shown in FIG. 6, similarly to S105 (see FIG. 3), it is determined whether or not the road on which the travel is traveling is a gradient road by use of the value of the road gradient et calculated immediately before. When it is determined in S205 that the absolute value of the latest road gradient et is equal to or larger than the threshold value θth, S206 and S207 related to the rough road determination are skipped, and the process proceeds to S208. In S208, similarly to S109 (see FIG. 3), a correction value P obtained by substituting the output value Vt of the posture sensor 21 into the correction function is calculated, and the process proceeds to S210.

Also, in the second embodiment described so far, the same effects as in the first embodiment can be obtained, and a period of time from the occurrence of the posture change to the rough road determination can be shortened. In addition, as in the second embodiment, with the employment of the display correction processing for stopping the determination of whether or not the road is a rough road based on the affirmative determination of the gradient road, the calculation load in the processing unit is reduced. In addition, even if the rough road determination is stopped, the correction control based on the output value Vt of the posture sensor 21 is continued. Therefore, in the smooth gradient road, the superimposed display in which the virtual image Vi is correctly superimposed on the superimposed target can be easily maintained.

In the display correction process according to the second embodiment, the processing contents of S201 to S204, S206, S207, S209 and S210 are substantially the same as the processing contents of S101 to S104, S107, S108, S110, and S111 (see FIG. 3) according to the first embodiment.

### OTHER EMBODIMENTS

Although the multiple embodiments according to the present disclosure have been described above, the present disclosure is not construed as being limited to the above-mentioned embodiments, and can be applied to various embodiments and combinations within a scope not departing from the spirit of the present disclosure.

In the second embodiment, as a result of stopping the rough road determination on the gradient road, the correction control based on the output value of the posture sensor is always executed while the vehicle is traveling on the gradient road. However, in a first modification of the second embodiment, when the rough road determination is stopped based on the affirmative determination of the gradient road, the correction control of the display position of the virtual image is also stopped. In other words, in the gradient road, the virtual image is fixed in a predefined predetermined position. Alternatively, in the gradient road, the display position of the virtual image may be corrected by use of a correction value obtained by applying the road gradient to the gradient correction function.

The driving force information in the above embodiments can be appropriately changed. For example, the drive torque information may be information indicating the target torque of the driving system calculated by the drive control device, instead of the detection value of the drive torque sensor. The source of the drive torque provided in the driving system may be an internal combustion engine, a motor generator, or a combination of the internal combustion engine and the motor generator.

In the above embodiments the height sensor is used as the posture sensor. However, the posture sensor may be a height sensor or the like that directly measures a distance from the vehicle body to the road surface by ultrasonic waves or laser light irradiated from the vehicle body toward the road surface. Further, the posture sensor may be an acceleration sensor for measuring acceleration in the vertical direction of the vehicle, a gyro sensor for detecting pitching of the vehicle, or the like.

In addition, in the configuration in which the height sensor is used as the posture sensor, the installation position of the height sensor is not limited to the rear wheel suspension device, and may be provided in the front wheel suspension device, for example. As described above, it is desirable that the posture sensor is capable of detecting the movement under the spring so that the roughness of the road surface is quickly reflected in the signal change.

The drive information acquisition unit according to the above embodiments acquires information on the vehicle speed from the wheel speed information acquired by the wheel speed acquisition unit. However, the above wheel speed information may be used for the rough road determination. For example, the rough road determination unit may compare the rotational speeds of the multiple wheels in the vehicle with each other, and determine that the vehicle is traveling on the rough road when a difference between the wheel speeds exceeds a predetermined threshold value.

The display control unit according to the above embodiments corrects the display position of the virtual image by the output process of attaching the correction data to the image data. However, the display control unit may output the image data in a state corrected by use of the correction value to the projector.

In the HUD device according to the above embodiments, the display position of the virtual image is adjusted by the process of adjusting the range to be cut out from the image data based on the correction data. However, the specific method of adjusting the display position of the virtual image can be appropriately changed. For example, adjustment of the display position of the virtual image may be realized by movement of a drawing position on the screen based on the correction data, movement of the projection region by the posture control of the catoptric system, or the like. Further, the display position of the virtual image may be corrected by a posture control mechanism that moves the entire HUD device based on the correction data.

The specific configuration of the HUD device can also be changed as appropriate. For example, the projector may be provided by a DLP (Digital Light Processing, registered trademark) projector using a DMD (Digital Micromirror Device). Further, a projector using an LCOS (Liquid Crystal On Silicon) or the like may be employed.

In the above embodiments, the correction control is interrupted based on the rough road determination. However, the method of inhibiting the correction control based on the rough road determination can be appropriately changed. For example, the inhibition of the correction control may be realized by narrowing the movable range of the virtual image based on the rough road determination. In addition, since the moving speed of the virtual image is limited based on the rough road determination, the movement of the virtual image that causes discomfort may be inhibited. Further, when the correction control is interrupted based on the rough road determination, the virtual image may be fixed at the position at the time of the interruption or may be moved to a specific position.

The display control unit according to the above embodiments continuously changes the correction amount of the virtual image display position in accordance with the output value of the posture sensor. However, the correction amount may be changed stepwise. In addition, the display position of the virtual image may be changed discontinuously based on the rough road determination. For example, when the rough road determination is performed on the gradient road, the display control unit may perform a display control for instantaneously switching the display position of the virtual image to the gradient correction position, instead of the display control for asymptotically approaching the virtual image to the gradient correction position.

The rough road determination unit according to the above embodiments can adjust the content of the rough road determination according to the vehicle speed. The content of the above adjustment can be appropriately changed. For example, the time widths of the driving force determination and the posture change determination may be continuously or stepwise changed in accordance with the vehicle speed. In the same manner, the threshold values Tth and Vth may be continuously or stepwise increased or decreased in accordance with the vehicle speed so that it is more difficult to determine that the road is a rough road as the speed is lower.

In the above embodiments, the rough road determination once performed is continued for a predetermined time. In the same manner, when the correction control of the display position is once inhibited, the state of inhibiting the correction control is continued for a predetermined time. However, if the accuracy of the rough road determination is sufficiently ensured, such a complementary process may be omitted.

In the above embodiments, each function provided by the control circuit of the display control device can be provided by software and hardware for executing the software, only software, only hardware, or a complex combination of the hardware and the software. Moreover, if the above functions are provided by an electronic circuit that is hardware, each function may also be provided by a digital circuit which includes multiple logic circuits, or an analog circuit.

In the above embodiments, the display control device implements the function of determining a rough road by executing the posture estimation program including the rough road determination program in the control circuit. However, for example, a rough road determination function may be implemented in the control circuit of the HUD device. In other words, the HUD device may correspond to a rough road determination device.

Further, another electronic control unit mounted on the vehicle may implement the function of determining the rough road. In addition, the result of the rough road determination can be used except for the display position correction of the virtual image displayed in an AR manner. For example, the result of the rough road determination may be used for the control of inhibiting the optical axis correction of the headlight.

Various non-transitory tangible storage media (non-transitory tangible storage medium) such as a flash memory and a hard disk can be employed as the memory device for storing the programs. The form of such a storage medium may also be changed as appropriate. For example, the storage medium may be in the form of a memory card or the like, inserted into a slot portion provided in the display control device, and electrically connected to the control circuit. Further, the storage medium is not limited to the memory device of the in-vehicle device as described above, and may be an optical disk serving as a copy base of the program to the memory device, a hard disk drive of a general-purpose computer, or the like.

The flowcharts or the processing depicted in the flowcharts described in the present disclosure include a plurality of sections (also referred to as steps) each of which is expressed as S101 or the like. Each of the sections can further be divided into a plurality of subsections, or a plurality of sections can be combined together to configure a single section. These sections can alternatively be referred to as circuits, devices, modules, or means.

Also, each or a combination of the plurality of portions may be implemented as (i) a portion of software in combination with a hardware unit (for example, a computer), as well as (ii) a portion of hardware (for example, an integrated circuit, a wired logic circuit), with or without the functionality of the associated device. Further, the hardware part can be configured inside the microcomputer.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A display control unit configured to control a virtual image display device configured to superimpose a virtual image on a foreground of an occupant of a vehicle, the display control unit comprising:
a posture information acquisition unit configured to acquire posture information indicating a change in posture of the vehicle based on a signal of a posture sensor attached to the vehicle;
a drive information acquisition unit configured to acquire driving force information indicating a state of a driving force acting on the vehicle;
a rough road determination unit configured to determine that the vehicle is traveling on a rough road when the change in posture indicated by the posture information exceeds a threshold value in a state where the driving force indicated by the driving force information is stable; and
a correction unit configured to (i) correct a deviation of a display position of the virtual image with respect to the foreground due to the change in posture of the vehicle based on the posture information, and (ii) inhibit the display position of the virtual image from being corrected and continue to superimpose the virtual image on the foreground when the rough road determination unit determines that the vehicle is traveling on the rough road.

2. The display control unit according to claim 1, wherein
the driving force information includes accelerator operation information and braking operation information.

3. The display control unit according to claim 1, wherein
the driving force information includes torque information of a driving system attached to the vehicle.

4. The display control unit according to claim 1, wherein
the rough road determination unit increases the threshold value as a traveling speed of the vehicle is lower.

5. The display control unit according to claim 1, wherein
once the rough road determination unit determines that the vehicle is traveling on the rough road, the rough road determination unit continues a determination result that the vehicle is traveling on the rough road for a predetermined time.

6. The display control unit according to claim 1, further comprising:
a position information acquisition unit configured to acquire position information indicating a current position of the vehicle; and
a map data acquisition unit configured to acquire three-dimensional map data including latitude, longitude, and altitude of the current position.

7. The display control unit according to claim 6, wherein
the rough road determination unit stops determining whether the vehicle is traveling on the rough road when an absolute value of a road gradient estimated from the three-dimensional map data exceeds a gradient threshold value.

8. The display control unit according to claim 6, further comprising
a change amount storage unit configured to store correlation data defining a correlation between a road gradient and the change in posture due to a weight of the vehicle, wherein
the correction unit corrects the deviation of the display position due to the road gradient based on the correlation data and the road gradient estimated from the three-dimensional map data.

9. The display control unit according to claim 8, wherein
when an absolute value of the road gradient estimated from the three-dimensional map data exceeds a gradient threshold value and the rough road determination unit determines that the vehicle is traveling on the rough road, the correction unit asymptotically approximates the display position of the virtual image from a current display position to a display position at which the deviation of the display position of the virtual image due to the road gradient is corrected.

10. The display control unit according to claim 1, wherein
the correction unit changes an amount for correcting the display position of the virtual image in accordance with a magnitude of the change in posture.

11. The display control unit according to claim 1, wherein
the correction unit continues to inhibit the display position of the virtual image from being corrected for a predetermined period once the rough road determination unit determines that the vehicle is traveling on the rough road.

12. The display control unit according to claim 1, wherein
the state where the driving force is stable indicates a case where the driving force is maintained equal to or less than a predetermined value for equal to or longer than a predetermined period.

13. The display control unit according to claim 1, wherein
the change in posture indicates a vertical displacement of the vehicle.

14. A non-transitory tangible computer readable storage medium comprising instructions executed by at least one processor of a display control unit, the at least one processor configured to control a virtual image display device configured to superimpose a virtual image on a foreground of an occupant of a vehicle, the at least one processor used for the vehicle to which a posture sensor is attached, the instructions comprising:
acquiring posture information indicating a change in posture of the vehicle based on a signal of the posture sensor;
acquiring driving force information indicating a state of a driving force acting on the vehicle;
determining that the vehicle is traveling on a rough road when the change in posture indicated by the posture information exceeds a threshold value in a state where the driving force indicated by the driving force information is stable;
correcting a deviation of a display position of the virtual image with respect to the foreground due to the change in posture of the vehicle based on the posture information; and
inhibiting the display position of the virtual image from being corrected and continuing to superimpose the virtual image on the foreground in the determining that the vehicle is traveling on the rough road.

15. A display control unit configured to control a virtual image display device configured to superimpose a virtual image on a foreground of an occupant of a vehicle, the display control unit comprising a processor configured to:
acquire posture information indicating a change in posture of the vehicle based on a signal of a posture sensor attached to the vehicle;
acquire driving force information indicating a state of a driving force acting on the vehicle;
determine that the vehicle is traveling on a rough road when the change in posture indicated by the posture information exceeds a threshold value in a state where the driving force indicated by the driving force information is stable;
correct a deviation of a display position of the virtual image with respect to the foreground due to the change in posture of the vehicle based on the posture information; and
inhibit the display position of the virtual image from being corrected and continue to superimpose the virtual image on the foreground when the processor determines that the vehicle is traveling on the rough road.
